(19) United States
(12) Patent Application Publication
(10) Pub. No.: US 2012/0034582 A1
(43) Pub. Date: Feb. 9, 2012

(54) READING TEACHING METHOD

(76) Inventor: Carl-Erik Petterson, Rydaholm (SE)

(21) Appl. No.: 12/850,031

(22) Filed: Aug. 4, 2010

(51) Int. Cl. G09B 17/00

(52) U.S. Cl. 434/178

(57) ABSTRACT

A method of teaching a person to read, based on short, intense reading sessions or lessons. After a suitable evaluation, a teacher establishes a plurality compilation of reading elements, starting with letters and which may progress in complexity to words. The student is positioned in close physical proximity to the teacher and reads the compilations aloud to an audible or sensible beat to promote a pace of reading. Reading speed of accurate reading may then be graphically illustrated to the student. Sessions including the above steps are performed in a short, intense period of perhaps fifteen minutes. Periodic sessions of the above steps may be repeated periodically such as two sessions per week for six to eight weeks.

### FIELD OF THE INVENTION

The present invention relates to education, and more particularly to a method of teaching people to read.

### BACKGROUND OF THE INVENTION

Some people have learning disabilities which interfere with normal learning. Ordinary teaching methods may not succeed with these people, or alternatively, may be less effective than desired.

An example of a condition which interferes with learning to read is dyslexia. Because many teaching methods are based on teaching combinations of letters as an elementary step, any condition which modifies the perception of letter combinations may defeat effectiveness of the lesson. Reading is an extremely fundamental skill in achieving information transfer in the modern world. Society can ill afford to leave members behind due to inadequate reading skills. Therefore, there exists a need to improve teaching methods which in particular are ineffective with students who have reading disabilities.

### SUMMARY OF THE INVENTION

The present invention provides a method of teaching people to read. The method is remarkably effective with students who have certain learning disabilities. The fundamental elements of this method cause effective engagement of the student, without which students having disabilities could be inadequately motivated to learn. The fundamental elements include a one-on-one relationship between student and teacher; close personal proximity of student and teacher; a return to the most fundamental elements of lessons at each learning session; a protocol which promotes reading at a rapid pace; and immediate feedback upon completion of a lesson.

There is an important psychological cumulative effect which results from the combination of the above recited fundamental elements which the inventors believe underlies effectiveness of the method. It is felt that there is criticality in engaging the student with an intense relationship with the teacher, to assure full intellectual effort by the student, that results in learning where other methods may fail.

It is an object of the invention to provide a learning method that succeeds with reading students who have disabilities.

It is an object of the invention to provide improved elements and arrangements thereof by apparatus for the purposes described which is fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a table of words which may be used for example in an initial evaluation.

FIG. 2 is an exemplary table of letters for a reading session.

FIG. 3 is an exemplary table of reading elements which is more complex than that of FIG. 2, for a reading session.

FIG. 4 is an exemplary graph illustrating student performance.

FIG. 5 is a block diagram of steps of performing the novel method.

### DETAILED DESCRIPTION

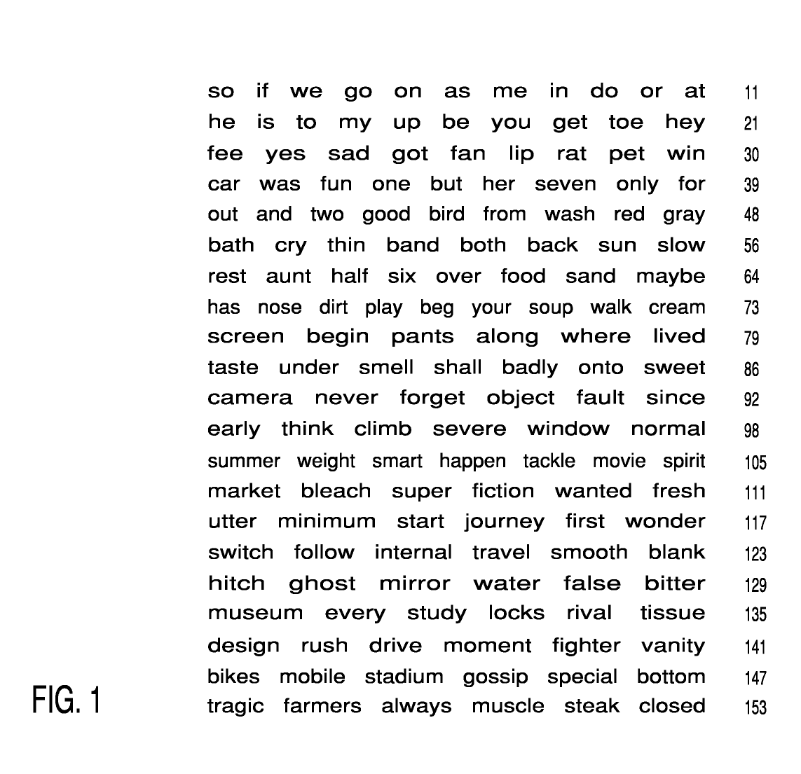

As with most teaching methods, the method of the present invention may start with an evaluation of a student's ability to read. The evaluation will establish the basic skills which must be imparted to the student. After the evaluation, lists of letters, letter combinations, and words of appropriate complexity and nature may be selected for lessons. FIG. 1 shows an exemplary list of words which the student may be asked to read as part of an evaluation.

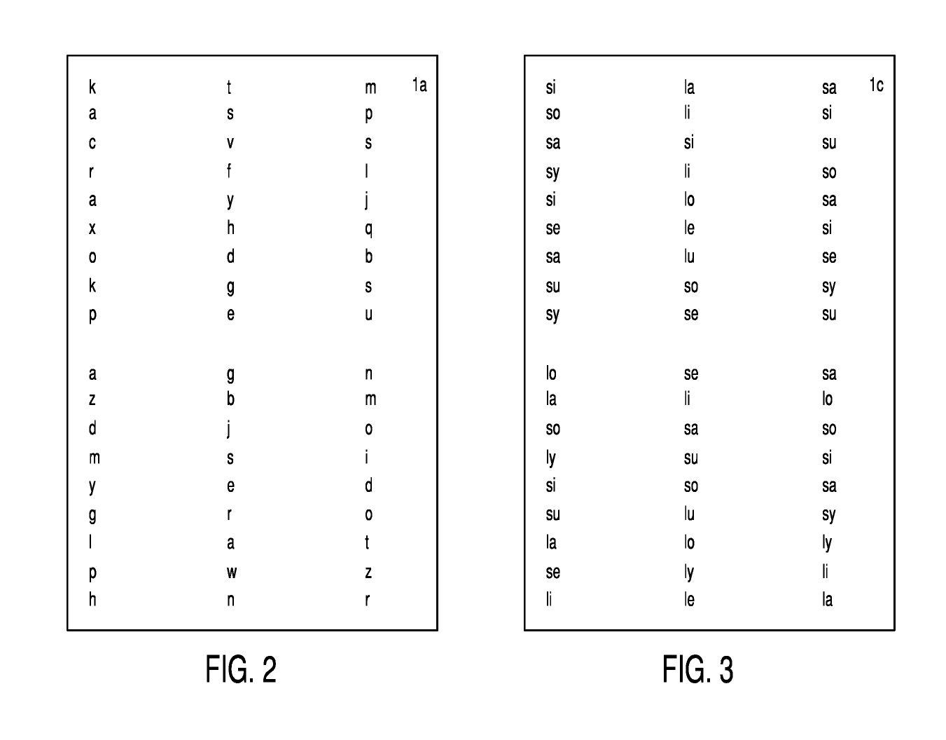

At the heart of the method is a series of reading sessions which feature decoding exercises. Notably, the student is asked to read from lists or compilations of reading subject matter. These compilations are ordered according to least complexity first, such as individual letters. An example is seen in FIG. 2. The lessons may progressive to reading elements of increased complexity. An example is seen in FIG. 3. Sessions are of generally short duration, twenty minutes for example. Of this, ten to fifteen minutes are devoted to intensive training and several minutes may be used for casual conversation. Because the novel method relies on a close working relationship between student and teacher, time spent on conversation will contribute to and not impair the lesson. The teacher is responsible for generating a sensible series of prompts to establish a pace at which the student reads. This series of prompts may be based on tapping a pen or pencil on a desk, or in any other suitable way.

Should the student make an error, the teacher halts the prompts, interruption of which cues the student that a correction should be made.

At the conclusion of each session, the student is then given immediate feedback as to progress.

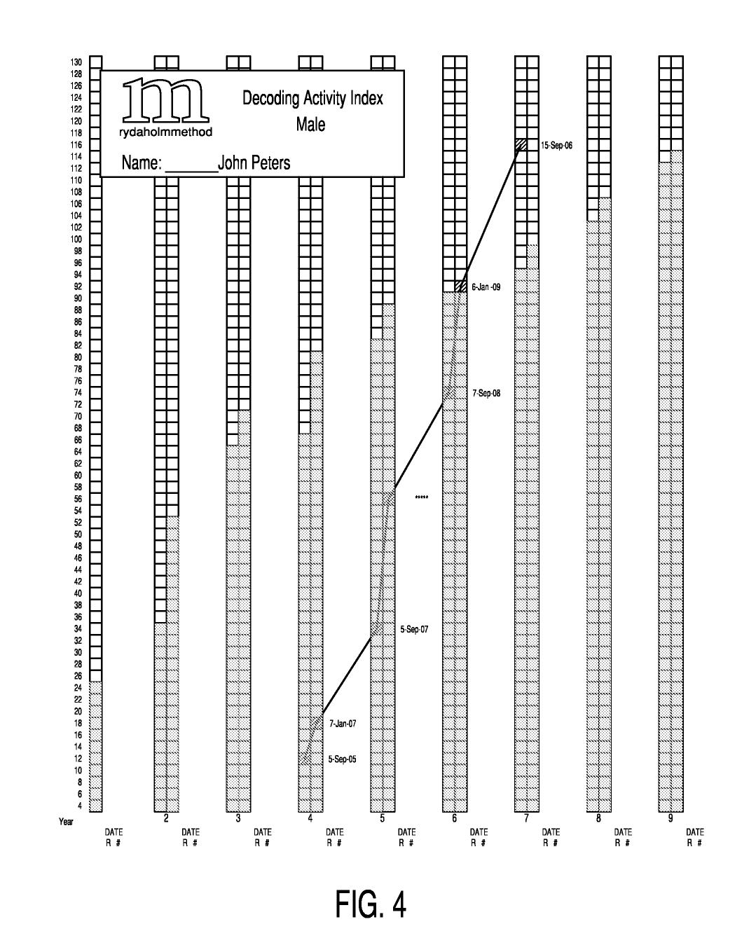

Preferably, this feedback is in graphic form, such as illustrated in FIG. 4. In FIG. 4, the number of reading elements correctly read is represented on a graph. The vertical scale shows the number of reading elements correctly read. The horizontal scale shows the reading sessions, such as by date. In a suitable amount of time, any single session is followed within a time interval of less than one week by a second session of short duration which is similar in format but different in content of read aloud elements.

Subsequent sessions may start with the first compilation of the prior session.

After an appropriate number of sessions, such as two sessions per week for six to eight weeks, and at the discretion of the teacher, an evaluation of the student is made. If the student has reached a desired proficiency in reading, lessons may be discontinued.

If the student has not reached a desired proficiency, further sessions are then undertaken, and may again be two sessions per week for six to eight weeks. The sessions may be discontinued when the student reaches the predetermined level of proficiency.

The results may be reported to a remote central station, such as the office of a professional education service which administers the novel method as a commercial service. The results may be sent by internet for example.

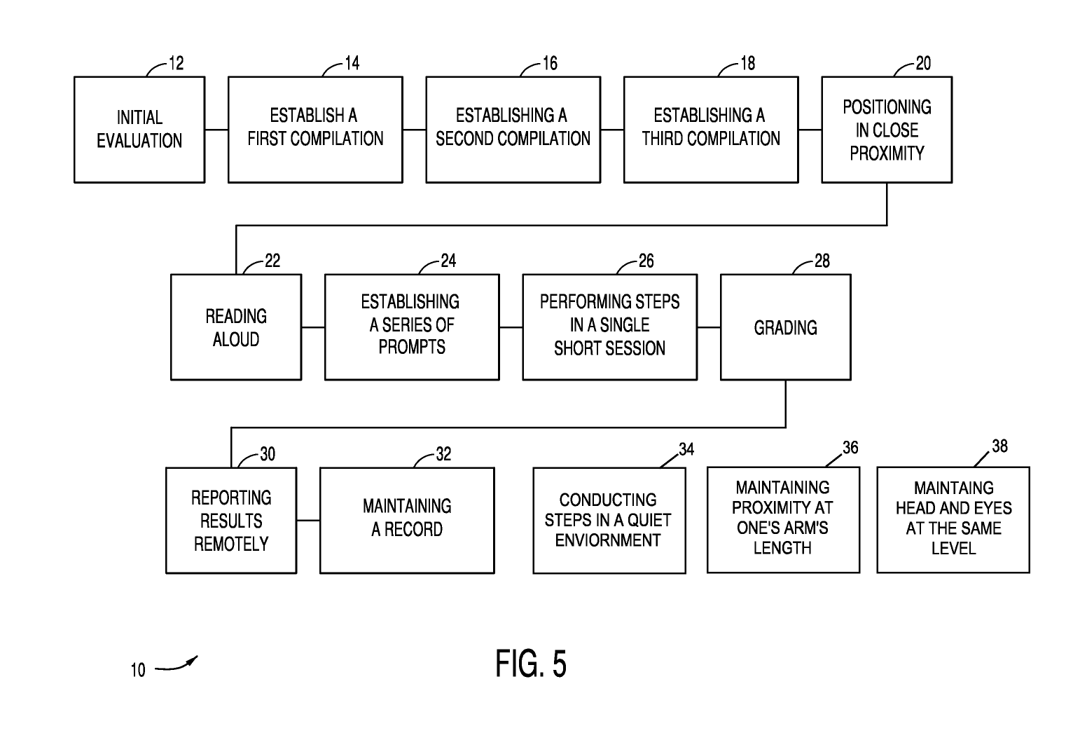

FIG. 5 shows the novel method 10 for teaching a student to read in discreet steps. An initial step 12 may be that of conducting the initial evaluation. This may be followed by a step 14 of establishing a first compilation containing letters, a step 16 of establishing a second compilation containing letters, wherein each member of the second compilation has at least one more letter than each member of the first compilation, and a step 18 of establishing a third compilation containing letters, wherein each member of the third compilation has at least one more letter than each member of the second compilation. The method 10 may comprise a step 20 of positioning the student in close physical proximity to a teacher. A step 22 may be that of having the student read aloud the first compilation, the second compilation, and the third compilation aloud. A step 24 may be that of establishing a timed series of prompts to promote a pace at which the student reads aloud. A significant aspect of the method 10 is the step 26 of causing the steps 14, 16, 18, 20, 22, and 24 to be performed in a single continuous session of short duration. This is because there is a significant psychological aspect relating to effectiveness of the novel method 10.

Further significant psychological aspects of effectiveness include the following. Firstly, to avoid undue distractions, the room or other environment in which the lessons are conducted must be quiet and free from visual and other sensible influences. Secondly, the teacher must actively engage the student by maintaining a proximity to the student of no greater distance of physical separation of about one arm's length. Thirdly, and again to actively engage the student psychologically, the head and eyes of the teacher and student should be at the same level, or alternatively stated, should be in a common horizontal plane. These aspects of the method 10 are seen as additional steps of the method 10, and will be presented hereinafter.

The steps 14, 16, and 18 may use compilations of reading elements such as those illustrated in FIGS. 1, 2, and 3, for example. In any one session, the first compilation, the second compilation, and the third compilation may be read aloud in order of increasing complexity.

After each session comes a step 28 of grading the single session as to accuracy immediately upon completion and advising the student immediately of the results of grading. Step 28 may use the graphic output illustrated in FIG. 4 for example. The same graph may be used in subsequent sessions, so that the student may see a steep increase in graphic results over the several sessions.

Where the method 10 is the commercial product of a professional education service, the method 10 may include the step 30 of reporting results to a remote location, and the step 32 of maintaining an ongoing record of results for all of the sessions undertaken by the student.

Returning to the issue of psychological engagement of the student by the teacher, the method 10 may be seen as incorporating a step 34 of conducting any and preferably all of the steps which include participation of the student, such as the steps 20, 22, 24, and 26, in an environment which is quiet and free from visual and other sensible influences.

The method 10 may include a step 36 of having the teacher actively engage the student by maintaining a proximity to the student limited to a distance of physical separation of about one arm's length. The method 10 may include a step 38 of maintaining the head and eyes of the teacher and student at the same level.

It will be appreciated that the various steps of the method may be ordered other than in the order as described herein. It will also be appreciated that some steps may be performed simultaneously with others. For example, producing a beat for pacing purposes is performed simultaneously with all steps of reading aloud. Therefore, the steps of the invention must be regarded as elements which are present rather than as a prescribed order in which the steps are to be performed.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A method for teaching a student to read, comprising the steps of
establishing a first compilation containing letters;
establishing a second compilation containing letters, wherein each member of the second compilation has at least one more letter than each member of the first compilation;
establishing a third compilation containing letters, wherein each member of the third compilation has at least one more letter than each member of the second compilation;
positioning the student in close physical proximity to a teacher;
having the student read aloud the first compilation, the second compilation, and the third compilation aloud;
establishing a timed series of prompts to promote a pace at which the student reads aloud; and
performing the steps of establishing a first compilation containing letters, establishing a second compilation containing letters, establishing a third compilation containing letters, positioning the student in close physical proximity to a teacher, having the student read aloud the first compilation, the second compilation, and the third compilation aloud, and establishing a timed series of prompts to promote a pace at which the student reads aloud are performed in a single session of short duration.

2. The method of claim 1, wherein the first compilation consists of single letters, the second compilation consists of short combinations of letters, and the third compilation consists of words.

3. The method of claim 1, wherein the first compilation, the second compilation, and the third compilation are read aloud in order of increasing complexity.

4. The method of claim 1, wherein the single session of short duration is followed within a time interval of less than one week by a second session of short duration which is similar in format but different in content of read aloud elements.

5. The method of claim 4, wherein the second session starts with the first compilation of the prior session.

6. The method of claim 1, wherein the timed series of prompts is halted should the student reading aloud make an error.

7. The method of claim 1, comprising the further step of grading the single session as to accuracy immediately upon completion and advising the student immediately of the results of grading.

8. The method of claim 4, comprising the further step of grading the single session as to accuracy and grading subsequent sessions as to accuracy by generating a graphic presentation of results.

9. The method of claim 1, comprising the further steps of
reporting results to a remote location, and
maintaining an ongoing record of results for all of the sessions undertaken by the student.

10. The method of claim 1, comprising the further step of conducting at least one said step which includes participation of the student in an environment which is quiet and free from visual and other sensible influences.

11. The method of claim 1, comprising the further step of having the teacher actively engage the student by maintaining a proximity to the student of no greater distance of physical separation of about one arm's length.

12. The method of claim 1, comprising the further step of maintaining the head and eyes of the teacher and student at the same level.
